(19) United States
(12) Patent Application Publication
(10) Pub. No.: US 2016/0154851 A1
(43) Pub. Date: Jun. 2, 2016

(54) COMPUTING DEVICE, STORAGE MEDIUM, AND DATA SEARCH METHOD

(71) Applicant: Hitachi, Ltd., Tokyo (JP)

(72) Inventors: Natsuko SUGAYA, Tokyo (JP); Michio IIJIMA, Tokyo (JP)

(73) Assignee: Hitachi Ltd., Tokyo (JP)

(21) Appl. No.: 14/423,746

(22) PCT Filed: Apr. 24, 2013
(86) PCT No.: PCT/JP2013/061965

§ 371 Date: Feb. 25, 2015

(51) Int. Cl. G06F 17/30

(52) U.S. Cl. CPC G06F 17/30477; G06F 17/30321

(57) ABSTRACT

It is possible to efficiently use an index search in a database search and to reduce the amount of processing of an actual data search. A computing machine has a storage unit which stores an index definition including information representing an index creation range of a search index created for a data group, and a control unit. The control unit detects, from a search target range included in a search request for the data group and an index definition, the inclusion relationship of at least a part of one of the search target range and the index creation range. When the inclusion relationship is detected, the control unit first executes an index search using the search index in response to the search request, then executes an actual data search in the search target range for document data excluding data, for which success or failure of a search request has been finalized by the index search, and outputs a search result.

### TECHNICAL FIELD

The present invention relates to a computing machine, a recording medium, and a data search method, and in particular, to a computing machine which extracts desired data from a data group, a non-transitory recording medium storing a program for executing this processing, and a data search method.

### BACKGROUND ART

The versatility of storage devices including an HDD and the increase in capacity thereof enables previously discarded mass data to be held therein. In recent years, the held mass data has been used in analysis, and has been used in business. For example, various analyses, such as analysis of structured log data, analysis of an unstructured portion of log data, and analysis of text data, such as short messages, have been done through trial and error.

Similarly, the DB index capacity significantly increases with the versatility of the storage devices and the increase in capacity thereof. An increase in DB indexes makes it possible to realize creation of multiple indexes having different characteristics in the same data or creation of indexes in multiple ranges in order to process mass data subjected to various analyses appropriately and quickly.

As an index format, various indexes including a “character string search index” and a “B-tree index” are known.

The “character string search index” refers to a format in which a partial character string to be a key is stored in association with the appearance position of the partial character string in data. The partial character string is extracted from text in units for a character string search, such as word, n-gram, or suffix array. When extracting a word from text, a method, such as morphological analysis, is used. As the method of extracting an n-gram from text, for example, PTL 2 discloses a technique which mechanically extracts a continuous character string of n characters. For example, NPL 2 discloses a technique which extracts a suffix array from text.

The “B-tree index” refers to, for example, an algorithm which increases the speed of a search with an index tree having a tree structure. For example, NPL 1 discloses a technique which performs a search from the top root page of a higher page and acquires appearance data information related to search target data on the bottom leaf page.

In this way, if multiple indexes are created in data including text data, it is necessary to select an index to be processed or a processing order. That is, a search order is optimized. An RDBMS optimization technique as a technique for selecting an index to be processed has been hitherto known. FIG. 20 shows a processing example of an RDBMS. FIG. 20 shows an example of an employee table 400 for managing employee ID, name, join date, department, and the like. Indexes 451, 452, . . . are created in column units of an employee number column 401 and a name column 402 for the employee table. During a search, an index in a range conforming to a column designated as a search target range by a search condition 500 included in a search request is used. Here, if there is no index in the range conforming to the column designated as the search target range, actual data of the column is collated.

For example, if the search condition is employee data “in the BBB department before the join date of Mar. 31, 2000”, first, join date data before Mar. 31, 2000 is searched for using the index 453 of the join date column 403. Actual data of the department column 404 is collated for a hit row, and a row of the BBB department is specified.

When the request is a search which is performed by a combination of multiple conditions, a system in which a processing order is determined with a key selection rate or collation cost as a guidance, or the like may be used.

PTL 1 discloses, as an optimization technique, “a database search processing system which evaluates load cost of multiple indexes regarding a search condition expression according to a key selection rate, selects an optimum index among these indexes, and loads records from a database using the selected index to execute search processing, having an advantage of selecting an optimum index, includes detection means for detecting density representing dispersion of records managed with indexes whose key selection rate is to be calculated, and correction means for correcting the key selection rate using the density detected by the detection means, and determines indexes for use in loading records according to the key selection rate corrected by the correction means”.

### CITATION LIST

### Patent literature

PTL 1: JP-A-7-311699

PTL 2: JP-A-1-035627

PTL 3: JP-A-4-274557

### Non-Patent literature

NPL 1: Transaction Processing: Concepts and Techniques (Jim Gray, Andreas Reuter) (“Transaction Processing <Second Volume>: Concepts and Techniques, ” written in Japanese by Nikkei BP, Inc (2001/10)) 15.4.1 B-trees: The Basic Idea

NPL 2: Manber, U. and Myers, G.: Suffix arrays: A new method for on-line string searches, in 1st ACM-SIAM, Symposium on Discrete Algorithms, pp. 319-327 (1990)

### SUMMARY OF INVENTION

### Technical Problem

On the other hand, since text data has no clear scheme, various ranges can be designated as an index creation target or a search target. In particular, in an analysis of mass data, since an analysis method is performed through trial and error, it is difficult to predict required processing at the time of index creation. For this reason, a created index may not be optimized for a search request. In the optimization system of the related art, there may be no usable indexes, and in this case, the collation of actual data is required (so-called, full text search). The load of processing for collating actual data has a great influence on performance with an increase in data to be processed.

### Solution to Problem

In order to solve the above-described problem, for example, a configuration described in the appended claims is provided. That is, a computing machine includes a storage unit which stores an index definition including information representing an index creation range of a search index created for a data group, and a control unit which detects, from a search target range included in a search request for the data group and the index definition, an inclusion relationship of at least a part of one of the search target range and the index creation range, executes an index search using the search index in response to the search request by the detection of the inclusion relationship, then executes an actual data search in the search target range for document data excluding data, for which success or failure of a search request has been finalized by the index search, in response to the search request, and outputs a search result for the search request.

### Advantageous Effects of Invention

According to one aspect of the invention, it is possible to realize efficient search processing in which the range to be processed by a document data search is reduced.

Objects, configurations, and effects other than those described above will become apparent from the following description of embodiments.

### BRIEF DESCRIPTION OF DRAWINGS

FIG. 1A is a conceptual diagram illustrating the principle of a computing system in a first embodiment which is an application example of the invention.

FIG. 1B is a conceptual diagram illustrating the principle of the computing system in the first embodiment which is an application example of the invention.

FIG. 1C is a conceptual diagram illustrating the principle of the computing system in the first embodiment which is an application example of the invention.

FIG. 2 is a schematic view showing the configuration of the computing system in the first embodiment.

FIG. 3 is a schematic view showing an example of an index definition file of the computing machine in the first embodiment.

FIG. 4A is a schematic view showing an example of an “omission complementation type” search plan in the first embodiment.

FIG. 4B is a schematic view showing an example of a “noise removal type” search plan in the first embodiment.

FIG. 4C is a schematic view showing an example of a “document data collation type” search plan in the first embodiment.

FIG. 5 is a flowchart showing the flow of processing of a data registration unit in the first embodiment.

FIG. 6 is a flowchart showing the flow of processing of an index creation unit in the first embodiment.

FIG. 7 is a flowchart showing the flow of processing of a data search unit in the first embodiment.

FIG. 8 is a flowchart showing the flow of processing of a search plan determination unit in the first embodiment.

FIG. 9 is a flowchart showing the flow of processing of a search execution unit in the first embodiment.

FIG. 10 is a flowchart showing the flow of processing of an index search unit in the first embodiment.

FIG. 11 is a flowchart showing the flow of processing of a document data collation unit in the first embodiment.

FIG. 12 is a conceptual diagram illustrating the principle of a computing system in a second embodiment which is an application example of the invention.

FIG. 13 is a schematic view showing the configuration of a computing system in the second embodiment.

FIG. 14 is a flowchart showing the flow of processing of a search plan determination unit in the second embodiment.

FIG. 15 is a flowchart showing the flow of processing of a search plan optimization unit in the first embodiment.

FIG. 16 is a schematic view showing the configuration of a computing system in a third embodiment.

FIG. 17A is a schematic view showing au example of a search plan using “filtering index” in the third embodiment.

FIG. 17B is a schematic view showing an example of a search plan using “key index” in the third embodiment.

FIG. 18 is a flowchart showing the flow of processing of a search plan determination unit in the third embodiment.

FIG. 19 is a flowchart showing the flow of processing of a multiple-index planning unit in the third embodiment.

FIG. 20 is a schematic view showing the outline of processing of an RDBMS of the related art.

### DESCRIPTION OF EMBODIMENTS

Hereinafter, a mode for carrying out the invention will be described referring to the drawings.

### First Embodiment

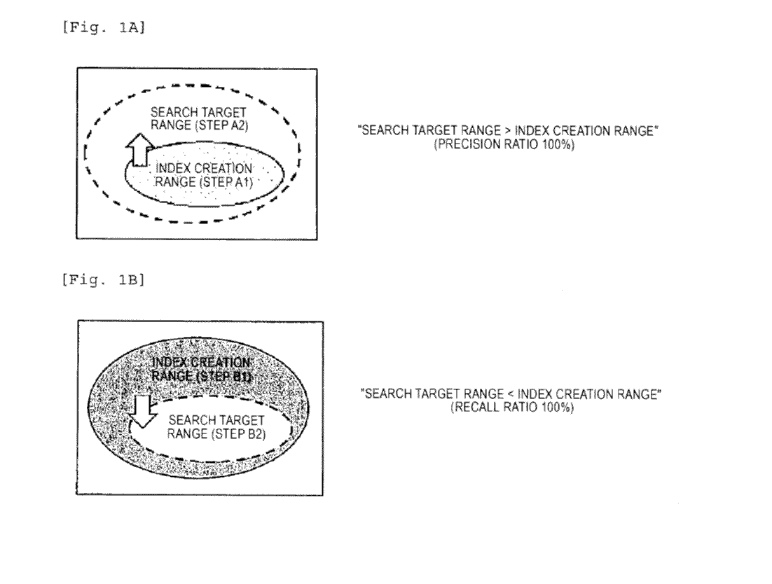

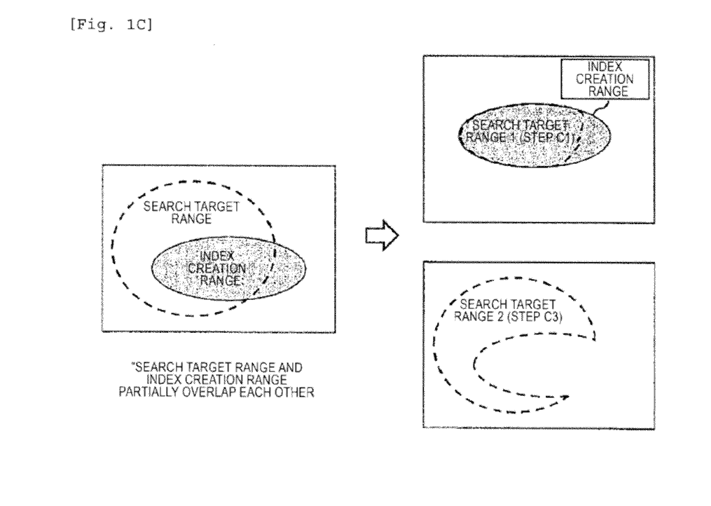

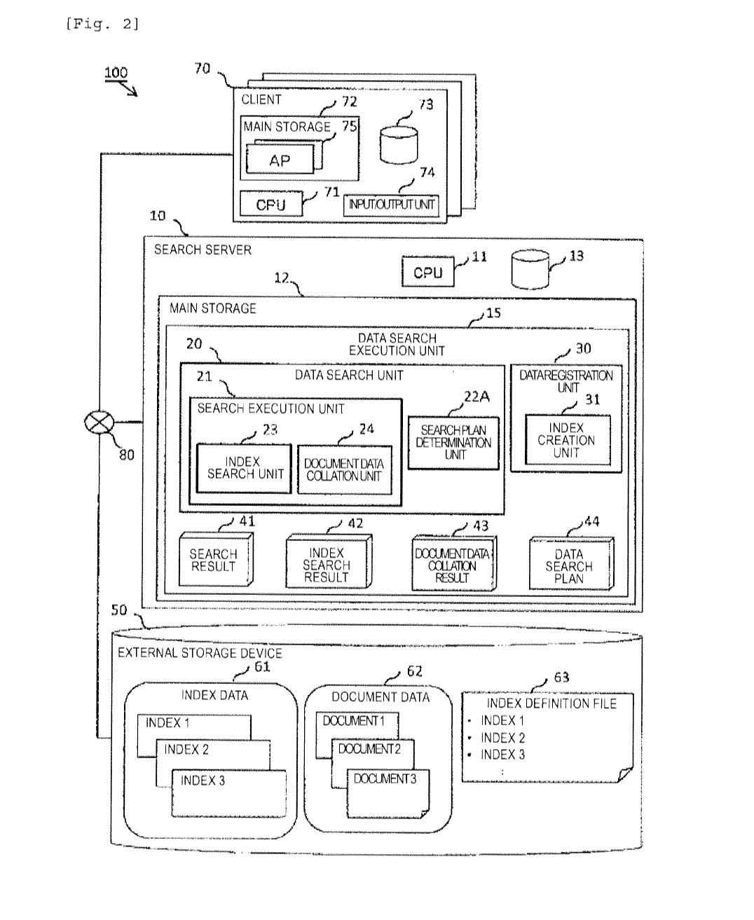

First, the principle outline of this embodiment will be described referring to a schematic view of FIG. 1.

A computing system 100 of this embodiment has a feature that search processing is first executed from an index creation range, and search processing of a search target range is executed using the result. As shown in FIGS. 1A and 1B, there is also a feature that, when the inclusion relationship between the index creation range and the search target range is different, the procedure for search processing is different.

In this embodiment, the ratio of the search target range included in the index creation range is defined as the precision ratio of the index to the search target range, and the ratio of the index creation range included in the search target range is defined as the recall ratio of the index to the search target range. In FIGS. 1A to 1B, a solid line rectangle represents an entire data range held by the computing system 100, the inside of an elliptical portion indicated by an inner dotted line represents a data search range requested by a search request from a client or the like, and the inside of an elliptical portion indicated by an inner solid line represents a range attached with an index.

FIG. 1A shows an example of an inclusion relationship in which a search target range of a search request is wider than an index creation range. A processing procedure in this case is as follows. An arrow in the drawing represents an order of a range where a search is performed.

First, the computing machine searches for data in the index creation range using an index (Step A1). Document data matching a condition in this search is determined as a correct document.

Next, the computing machine searches the search target range with actual data for document data mismatching the condition in Step A1 (Step A2). That is, an actual data search (document data search) is performed for document data in the search target range excluding the index creation range.

Finally, the computing machine merges document data matching the search conditions in the search processing of Step A1 and Step A2 to obtain a search result.

Specifically, a case where an index is created in “leading one line” of text data having multiple lines and “leading one paragraph” is designated as a search target is considered. First, the “leading one line” is searched with the index. However, the result may have detection omission. For this reason, the “leading one paragraph” is searched with actual data for a document mismatching the condition (document data of a paragraph mismatching the condition in the index search). Finally, matching document data by the index search and the actual data is merged and becomes a search result.

Meanwhile, FIG. 1B shows an example of an inclusion relationship in which a search target range of a search request is narrower than an index creation range. A processing procedure in this case is as follows.

First, the computing machine searches an index creation range using an index (Step B1). Document data matching a condition in this search processing includes search noise.

Next, the computing machine searches the search target range with actual data for document data matching the condition in Step B1 (Step B2). That is, a document data search is executed in a range obtained by excluding the creation range of the search index from the search target range.

The computing machine obtains a matching document in Step B2 as a search result.

Specifically, a case where an index is created in “leading one paragraph”, and “leading one line” is designated as a search target is considered. First, “leading one paragraph” is searched with the index. However, the result has search noise. For this reason, “leading one line” is searched with actual data for matching document data. Matching document data is obtained as a search result.

In the inclusion relationships of FIGS. 1A and 1B, it can be said that, according to the above-described definition, FIG. 1A becomes an index having a precision ratio of 100% such that matching document data by the index search becomes a correct document, and FIG. 1B is an index having a recall ratio of 100% such that an entire correct document is included in an index search. That is, an index having a precision ratio of 100% is an index with no search noise for a search target, and an index having a recall ratio of 100% is an index with no detection omission for a search target.

There is also a case where a search target range and an index creation range partially overlap each other.

FIG. 1C shows an example where both of a search target range and an index creation range partially overlap each other. Processing in this case is performed through the following procedure. First, the computing machine divides a target into a range (search target range 1) out of an index creation range included in a search target range and a range (search target range 2) out of the search target range excluding a portion overlapping the index creation range, and performs processing (Step C1).

The computing machine performs the above-described processing of FIG. 1B for a range (search target range 1/inside of the dotted line) satisfying the inclusion relationship, and examines the relationship with a different index and recursively repeats the processing for the other range (search target range 2) (Step C2).

The computing machine searches for actual data when a search target range not overlapping any index finally remains (Step C3).

According to this method, it is possible to reduce the range where actual data is searched using most of created indexes.

The principle of this embodiment is described above.

Hereinafter, detailed description of this embodiment will be provided.

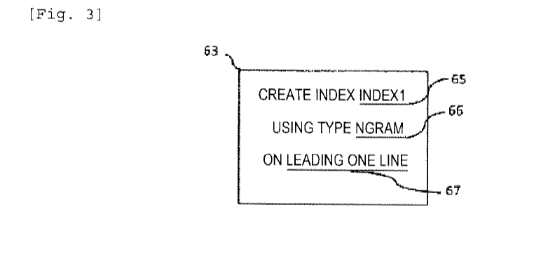

FIG. 2 schematically shows the configuration of a computing system 100 in the first embodiment. The computing system 100 has one or more clients 70, a search server 10, and an external storage device which are communicably connected together through a communication line 80 (including a wired and/or wireless network or the like).

As the client 70, a general-purpose server, a PC, or a communication terminal having a CPU 71, a main storage 72, an auxiliary storage 73, and an input/output unit 74, is applied. An application program (AP) 75 having a search request function is realized in the main storage unit 75 by cooperation between the CPU 71 and a program, transmits a data search request to the search server 10, and receives the result for the data search request.

As the search server 10, a general-purpose server machine having a CPU 11, a main storage 12, an auxiliary storage 13, and various external communication devices (not shown) is applied. A data search execution unit 15 is realized in the main storage unit 12 by cooperation between the CPU 11 and a program, and executes data search processing from the client 70. The details will be described below.

As the external storage device 50, a storage machine having a storage device, such as an HDD, an SSD, and/or a magnetic tape, is applied. The external storage device 50 stores an index definition file 63 which is auxiliary information for use in data search, document data 62 which is actual data, and index data 61, and responds with predetermined data according to a data acquisition request from the search server 10. Individual indexes 1, 2, 3, . . . in index data 61 are associated with definition information of the index definition file 63 on one-to-one basis.

FIG. 3 schematically shows an example of the definition information of the index definition file 63. The definition information includes an index name 65 (“CREATE INDEX”) representing the name of an index to be created, an index format 66 (“USING TYPE”), and an index creation range 67 (“ON”). In this embodiment, an example where “INDEX1” is defined as the index name 65, “NGRAM” is defined as the index format 66, and “leading one line” is defined as the index creation range 67 is described.

As the index format 66, a B-tree or various character string search indexes may be designated.

The index creation range 67 is, for example, attribute information attached to registration data, a structure range, such as “leading one line” or “leading one paragraph”, a character type range, such as a character string having continuous numerical values or letters, a character string conforming to a regular expression, or the like. In FIG. 3, an example where “leading one line” is defined is described.

Returning to FIG. 2, the search server 10 will be described in detail.

In the data search execution unit 15 of the search server 10, a data search unit 20 and a data registration unit 30 are realized, and a storage region where a search result 41, an index search result 42, a document data collation result 43, and a data search plan 44 are stored is secured.

In the data registration unit 30, when a processing request transmitted from the client 70 is a registration request (update request) of data, data registration and index generation processing are executed. Specifically, an identifier corresponding to registration data included in the registration request is generated, and an index creation unit 31 creates an index based on the identifier and registration data. If the index creation processing is completed, the data registration unit 30 transmits registration data to the external storage device 50 as document data 62 and transmits a corresponding identifier to the AP 75 of the client.

The data search unit 20 executes search processing of data according to a search plan determined by a search plan determination unit 22A in response to the search request from the client 70. The search processing is executed by an index search unit 23 which executes a search using index data 61 and a document data collation unit 24 which performs an actual data search with document data 62.

The search plan determination unit 22A determines a search plan, which defines a search order in the data search unit 20, from the search request and the index definition transmitted from the data search unit 20. Specifically, a search target range and a search condition are extracted by parsing the search request, and a precision ratio and a recall ratio of the index creation range to the search target range are calculated. For example, when the search request is “leading one paragraph {“data mining” AND “analysis”}”, “leading one paragraph” is a search target range, and ““data mining” AND “analysis”” are search conditions. The precision ratio and the recall ratio of each index creation range to the search target range are calculated from these and the definition information of the index definition file. The precision ratio and the recall ratio are calculated for all index definitions transmitted from the data search unit 20.

Thereafter, the search plan determination unit 22A creates a “search plan” according to the relationship between the calculated recall ratio and precision ratio. The “search plan” is information representing a search order in the data search unit 20. For example, in case of an RDBMS, the search plan corresponds to an execution plan. The created “search plan” is stored in the data search plan 44. As the “search plan”, there are a “noise removal type search plan”, an “omission complementation type search plan” and a “document data collation search plan”. While means for confirming an execution plan is different for each implementation, many RDBMSs prepare a command for confirmation from an interface of a command line.

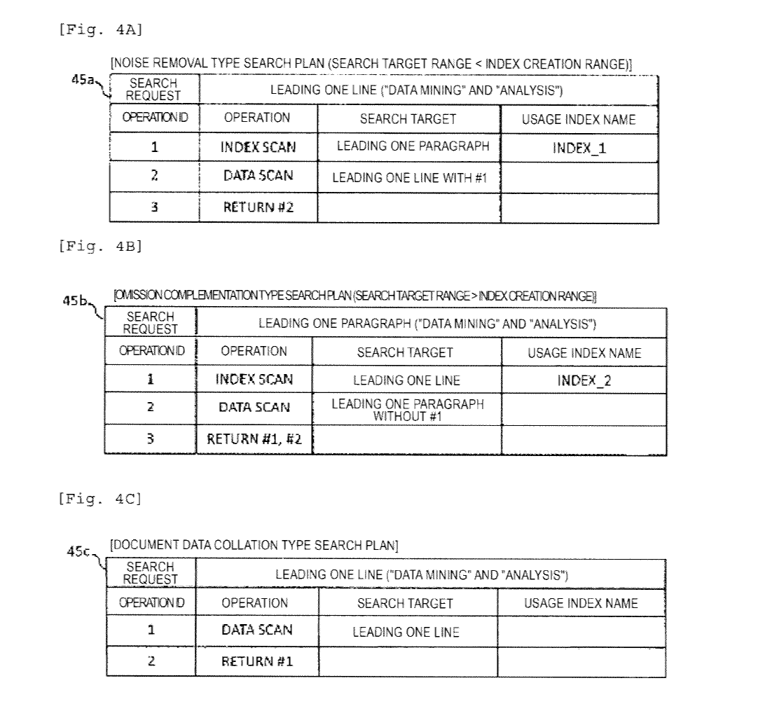

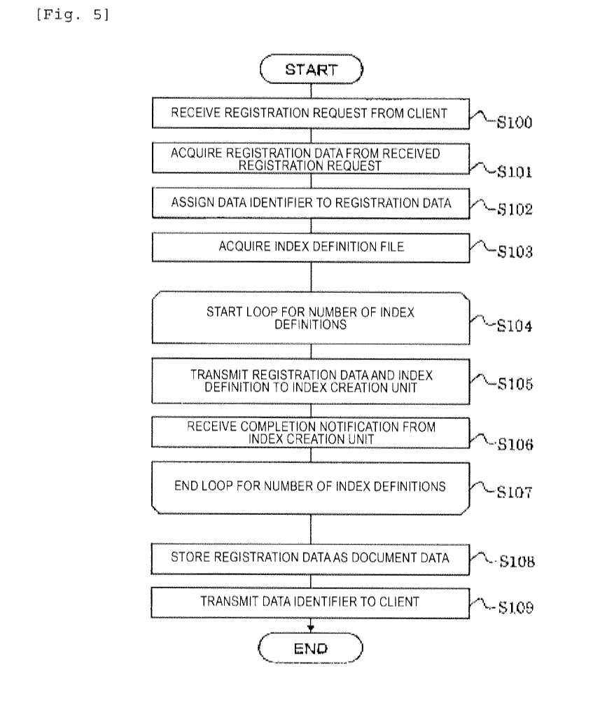

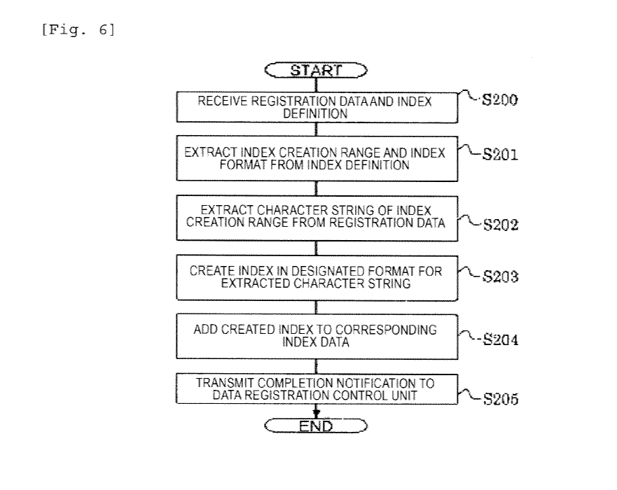

FIGS. 4A to 4C show examples of respective search plans. A search plan stores a search request and a processing procedure. The processing procedure is constituted by multiple operations, and one operation includes an operation ID, an operation, a search target, and a usage index name (blank when no index is used).

FIG. 4A shows an example of a “noise removal type search plan”. This plan is a procedure for search processing using an index having the highest precision ratio among indexes (the state of FIG. 1B) having a recall ratio of 100% from the result of the recall ratio and the precision ratio calculated by the search plan determination unit 22A. While there is no index having both a recall ratio and a precision ratio of 100%, when there is an index having a recall ratio greater than 0% (the state of FIG. 1C), the same search plan is created for the overlapping portion (“search target range 1” of FIG. 1C) of the search target range and the index creation range. Specifically, an index having the highest recall ratio is selected, and a search target range (“search target range 1” of FIG. 1C) where the recall ratio of the index becomes 100% is cut. Search processing using the selected index is performed for the cut range.

FIG. 4A shows an example where an index search is performed using INDEX_1 through an operation 1, a search of actual data is performed for a matching document in the operation 1 through an operation 2, and the result of the operation 2 is returned through an operation 3.

FIG. 4B shows an example of an “omission complementation type search plan”. This plan is a procedure for search processing using an index having the highest recall ratio among indexes (the state of FIG. 1A) having a precision ratio of 100% with no index having a recall ratio of 100% from the result of the recall ratio and the precision ratio calculated by the search plan determination unit 22A.

FIG. 4B shows an example where an index search is performed using INDEX_2 through an operation 1, a search of actual data is performed for mismatching document data in the operation 1 through an operation 2, and the results of the operation 1 and the operation 2 are returned through an operation 3.

FIG. 4C shows an example of a “document data collation search plan”. This plan is a procedure for search processing when there is only an index having a recall ratio of 0% with no indexes having both a recall ratio and a precision ratio of 100% (when there is no overlapping range) from the result of the recall ratio and the precision ratio calculated by the search plan determination unit 22A.

FIG. 4C shows an example where a search of actual data is performed through an operation 1, and the result of the operation 1 is returned through an operation 2.

Returning to FIG. 2, the search result 41 is a small region where a search result of search processing by the data search unit 20 is stored, and the result stored in this region becomes a response to the search request from the client 70.

The index search result 42 is a storage region where a search result by the index search unit 23 is temporarily stored A part of or the entire search result is stored in the search result 41 as a final search result by the data search unit 20 according to various “search plans” described below.

The document data collation result 43 is a storage region where a search result of actual data search processing by the document data collation unit 24 is temporarily stored. A part of or the entire search result stored this region is stored in the search result 41 as a final search result by the data search unit 20 according to various “search plans” described below.

The configuration of the computing system 100 is described above.

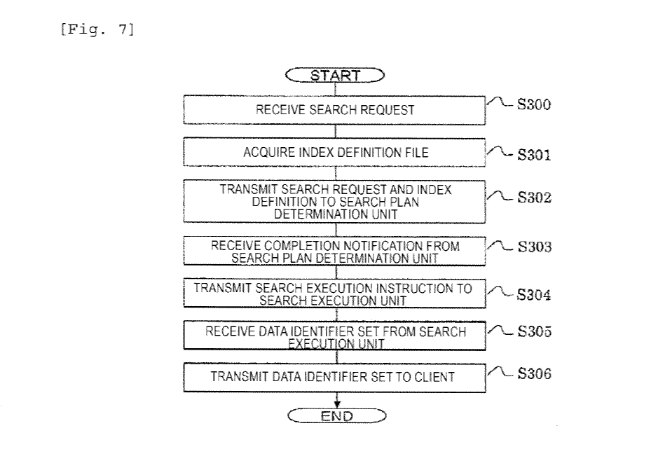

Next, the flow of processing of the respective functional units of the computing system 100 will be described using the flowcharts of FIGS. 5 to 11.

FIG. 5 shows the flow of processing of the data registration unit 30.

First, in S100, the data registration unit 30 receives a registration request from the client 70. In S101, the data registration unit 30 acquires registration data from the registration request. Registration data may be stored in the external storage device 50 and a storage destination may be described in the registration request, or registration data may be directly described in the registration request. Registration data may registered piece by piece, or multiple pieces of registration data may be collectively processed.

In S102, the data registration unit 30 assigns an identifier to the acquired registration data. The identifier is information unique to each piece of data, and if a data identifier is designated, data is determined uniquely.

In S103, the data registration unit 30 acquires the index definition file 63. A series of processing of S104 to S107 described below is repeated for the number of definitions described in the index definition file 63.

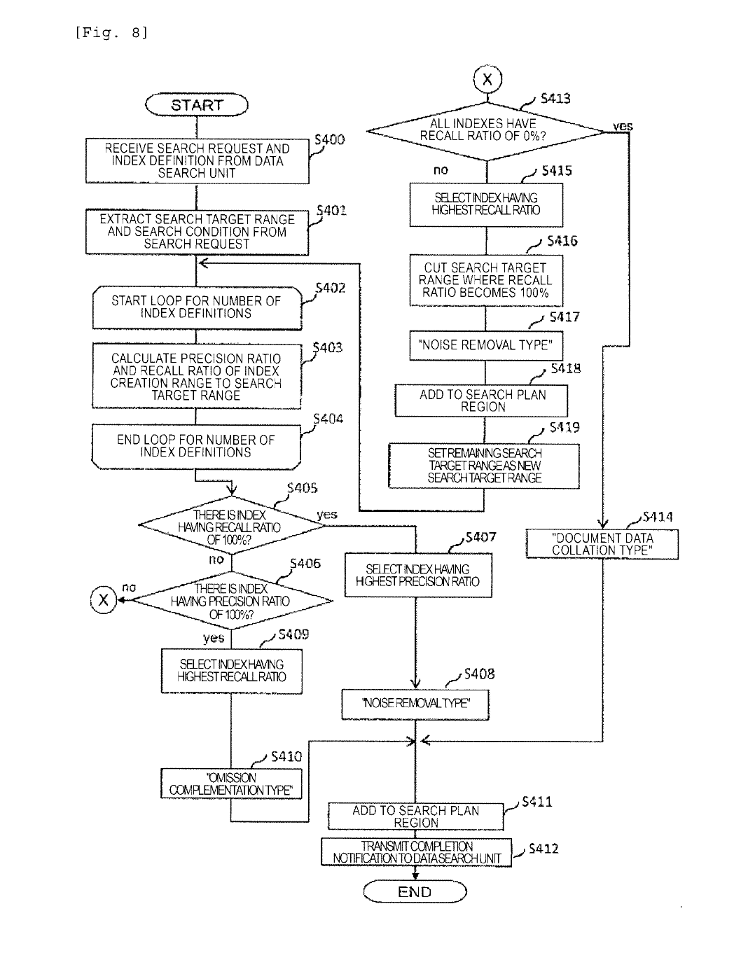

During the repetitive processing, in S105, the data registration unit 30 transmits registration data and the index definition to the index creation unit 31, and instructs the index creation unit 31 to create an index. Detailed processing of the index creation unit will be described below referring to FIG. 6.

If the index creation processing by the index creation unit 31 ends, in S106, the data registration unit 30 receives a completion notification from the index creation unit 31.

If the repetitive processing from S104 to S107 ends, in S108, the data registration unit 30 stores registration data on the external storage device 50 as document data 62.

Finally, in S109, the data registration unit 30 transmits the data identifier generated in S102 to the client 70, and this processing ends.

FIG. 6 shows the flow of processing of the index creation unit 31.

In S200, the index creation unit 31 receives registration data and the index definition 63 from the data registration unit 30.

In S201, the index creation unit 31 extracts an index creation range and an index format (for example, index creation range 67 and index format 66 of FIG. 3) from the index definition 63.

In S202, the index creation unit 31 extracts a character string designated by the index creation range from registration data.

In S203, an index is created in the designated index format for the extracted character string.

In S204, the created index is added to corresponding index data on the external storage device 50. Finally, in S205, a completion notification is transmitted to the data registration unit 30, and this processing ends.

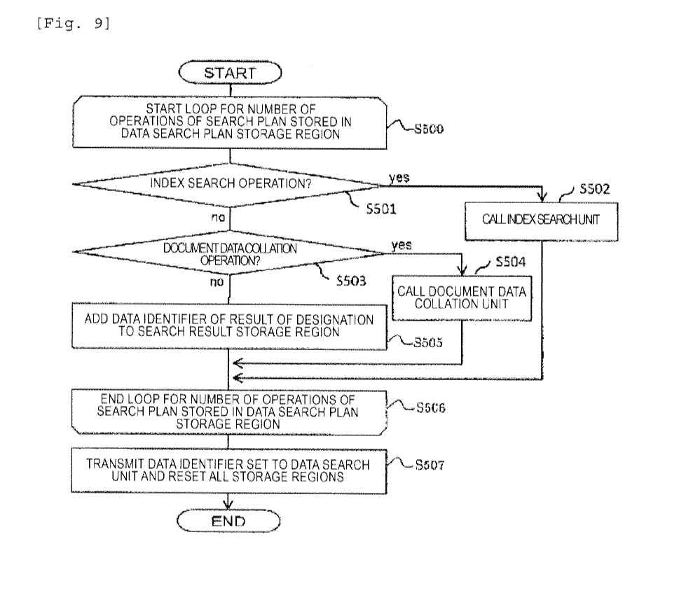

FIG. 7 shows the flow of processing of the data search unit 20.

In S300, the data search unit 20 receives the search request from the client 70.

In S301, the data search unit 20 acquires the index definition file 63 from the external storage device 50.

In S302, the data search unit 20 transmits the search request and the definition information of the index definition file to the search plan determination unit 22A, and instructs the search plan determination unit 22A to determine a search pan. The details of search plan determination processing will be described below.

If the search plan determination processing by the search plan determination unit 22A ends, in S303, the data search unit 20 receives a completion notification from the search plan determination unit 22A.

In S304, the data search unit 20 transmits a data search instruction to the search execution unit 21.

If the data search processing by the search execution unit 21 ends, in S305, the data search unit 20 receives a set of data identifiers from the search execution unit 21. This set is a set of identifiers of document data matching the search request.

Finally, in S306, the received set of data identifiers is transmitted to the client 70, and this processing ends.

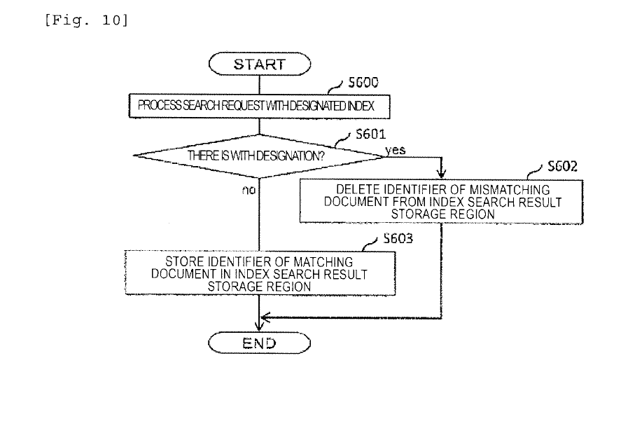

FIG. 8 shows the flow of processing of the search plan determination unit 22A.

In S400, the search plan determination unit 22A receives the search request and the definition information of the index definition file 63 from the data search unit 20.

In S401, the search plan determination unit 22A parses the search request and extracts a search target range and a search condition. For example, if the search request is “leading one paragraph {“data mining” AND “analysis”}”, the search target range is “leading one paragraph”, and the search conditions are ““data mining” AND “analysis ””. Next, a series of processing of S402 to S404 is repeated for the number of index definitions.

During the repetitive processing, in S403, the search plan determination unit 22A calculates a precision ratio and a recall ratio of an index creation range to the search target range.

If the repetitive processing of S402 to S404 ends, in S405, the search plan determination unit 22A checks whether or not there is an index having a recall ratio of 100%. When it is determined that there is an index having a recall ratio of 100% (S405: Yes), the processing progresses to S407, and when it is determined that there is no index having a recall ratio of 100% (S405: No), the processing progresses to S406.

In S407, the search plan determination unit 22A selects an index having the highest precision ratio among indexes having the recall ratio of 100%.

In S408, the search plan determination unit 22A creates a “noise removal type search plan” using the selected index. Thereafter, in S411, the search plan determination unit 22A adds the created search plan to the storage region of the data search plan 44, in S412, transmits a completion notification to the data search unit 21, and ends this flow.

In the meantime, in S406, the search plan determination unit 22A checks whether or not there is an index having a precision ratio of 100%. When it is determined that there is an index having a precision ratio of 100% (S406: Yes), the processing progresses to S409, and when it is determined that there is no index having a precision ratio of 100% (S406: No), the processing progresses to S413.

In S409, the search plan determination unit 22A selects an index having the highest recall ratio among the indexes having a precision ratio of 100%.

In S410, the search plan determination unit 22A creates an “omission complementation type search plan” using the selected index. Thereafter, the processing progresses to S411 and S412, and this flow ends.

In the meantime, in S413, the search plan determination unit 22A checks whether or not the recall ratios of all indexes are 0%. When the search plan determination unit 22A determines that the recall ratios of all indexes are 0% (S413: Yes), the processing progresses to S414, and “document data collation type search plan” is created. Thereafter, the processing progresses to S411 and S412, and this flow ends.

In S415, the search plan determination unit 22A selects an index having a maximum recall ratio greater than 0% among the recall ratios checked in S413.

In S416, processing for cutting a search target range of an index is performed such that the recall ratio of the selected index becomes 100%. For example, a search target range is cut so as to become the range of the search target range 1 of FIG. 1C.

In S417, the search plan determination unit 22A creates a “noise removal type search plan” using the selected index for the cut range (the search target range 1 in the upper right view of FIG. 1C), and in S418, then stores the created search plan in the storage region of the data search plan 44.

Thereafter, in S419, the search plan determination unit 22A sets the remaining search target range (the search target range 2 in FIG. 1C) as a new search target range, and returns to the repetitive processing of S402.

Next, the flow of processing of the search execution unit 21 which executes a search based on a created search plan will be described.

FIG. 9 shows the flow of processing of the search execution unit 21. The search execution unit 21 first repeats a series of processing of S500 to S506 according to the number of operations stored in the data search plan 44 and the operation ID.

In S501, it is checked whether or not an operation of the data search plan 44 is an index search operation. When it is determined that an operation is an index search operation (S501: Yes), the processing progresses to S502, and the index search unit 23 is called. When it is determined that an operation is not an index operation (S501: No), the data search unit 22 progresses to S503.

In S503, the search execution unit 21 checks whether or not an operation is a document data collation operation. When it is determined that an operation is a document data collation operation (S503: Yes), the processing progresses to S504, and the document data collation unit 24 is called. When it is determined that an operation is not a document data collation operation (S503: No), the processing progresses to S505, and the data search unit 22 adds the data identifier of the result of the designation to the storage region of the search result 41.

In S507, the search execution unit 21 transmits a set of data identifiers stored in the storage region of the search result 41, all storage regions are reset, and the processing ends.

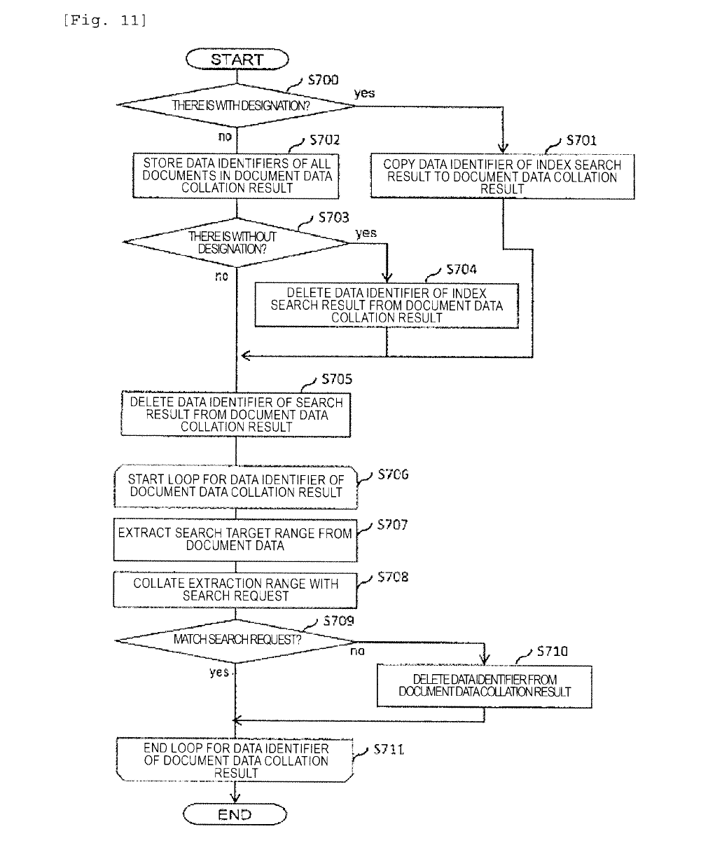

FIG. 10 shows the flow of processing of the index search unit 23.

In S600, the index search unit 23 processes a search request using an index designated in an operation of a search plan.

In S601, it is checked whether or not “WITH” is designated in an operation. When it is determined in S601 that “WITH” is designated in an operation (S601: Yes), the index search unit 23 progresses to S602, deletes an identifier of a mismatching document from the storage region of the index search result 42, and ends this processing.

Finally, the processing of the document data collation unit 24 will be described.

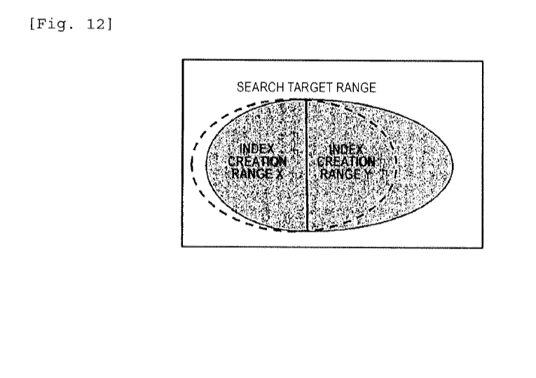

FIG. 11 shows the flow of document data collation processing.

In S700, the document data collation unit 24 checks whether or not “WITH” is designated in the operation of the search plan. When it determined that “WITH” is designated (S700: Yes), the processing progresses to S701, and when it is determined that “WITH” is not designated (S700: No), the processing progresses to S702.

In S701, the document data collation unit 24 copies the data identifier stored in the storage region of the index search result 42 to the storage region of the document data collation result 43. This step is processing for executing a “noise removal type search plan”.

In S702, the document data collation unit 24 stores the data identifiers of all documents in the storage region of the document data collation result 43.

In S703, the document data collation unit 24 checks whether or not “WITHOUT” is designated in the operation. When it is determined that “WITHOUT” is designated (S703: Yes), the processing progresses to S704, and when it is determined that “WITHOUT” is not designated (S703: No), the same identifier as the data identifier stored in the storage region of the index search result 44 is deleted from the document data collation result 44. This step is processing for executing an “omission complementation type search plan”.

In S705, the document data collation unit 24 deletes the same identifier as the data identifier stored in the storage region of the search result 41 from the storage region of the document data collation result 44. This step is executed so as to omit processing regarding a document already determined to be a correct document.

Next, the document data collation unit 24 repeats a series of processing of S706 to S711 for the number of data identifiers stored in the storage region of the document data collation result 43.

In S707, the document data collation unit 24 extracts a character string of a designated search target range from document data.

In S708, the document data collation unit 24 collates the extracted range with the search request, and in S709, checks whether or not the extracted range matches the search request. When it is determined that the extracted range does not match the search request (S709: No), the processing progresses to S710, and when it is determined that the extracted range matches the search request (S709: Yes), the processing progresses to S711.

In S710, the document data collation unit 24 deletes the data identifier from the storage region of the document data collation result 43. If the repetitive processing of S706 to S711 ends, this flow ends.

As described above, according to the computing system 100 of the first embodiment, when a search target range is different from an index creation range, a search is performed from the index creation range, and the search target range is searched using the result. Therefore, even in a large-scale document database, it is possible to provide a data search device which realizes fast search processing using most of created indexes.

### Second Embodiment

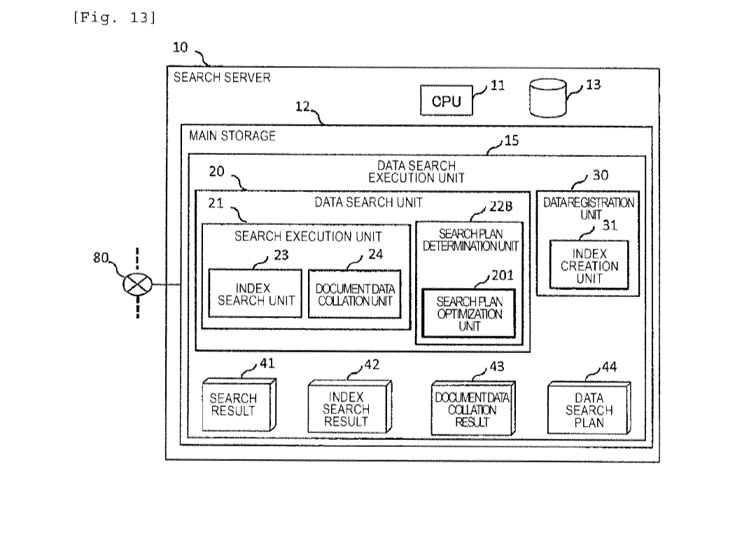

Next, a computing system 200 of a second embodiment to which the invention is applied will be described. The principle of the computing system 200 will be described referring to FIG. 12. As shown in the drawing, the computing system 200 has a configuration in which a search target range (in the drawing, an elliptical portion indicated by a dotted line) is divided into multiple index creation ranges X and Y (in the drawing, a hatched semielliptical portion surrounded by a solid line). The index creation range X is narrower than the index creation range Y. The computing system 200 of the second embodiment has a feature that search processing using an index in a narrower index creation range is preferentially performed. That is, since there is an increasing possibility that a processing time is shortened in a narrow index creation range, there is an increasing probability that search processing using an index in a narrow range is first started, and as a result, the speed of the entire search processing is increased.

For example, in case of a B-tree index, the narrower a range where an index is created, the smaller the number of key values or the shallower a tree hierarchy. For this reason, there is an increasing possibility that the speed of search processing is increased. In case of an n-gram index, the narrower a range where an index is created, the smaller the amount of positional information stored in an individual index. For this reason, there is an increasing possibility that the speed of search processing is increased.

Hereinafter, the computing system 200 will be described in detail. The components and functional units having the same configurations as those in the computing system 100 (FIG. 2) of the first embodiment are represented by the same reference numerals, and detailed description thereof will not be repeated.

FIG. 13 partially shows a configuration in the computing system 200 (search server 10). A major difference is that a search plan determination unit 22B of the search server 10 has a search plan optimization unit 201.

In the search plan optimization unit 201, the search plan determination unit 22 executes processing for rearranging the operation order of a “search plan” created in the same manner as in the first embodiment. Specifically, the “search plan” created by the search plan determination unit 22 is rearranged such that a search using a search index in an ascending order of the length of the index creation range in the index definition is preferentially executed.

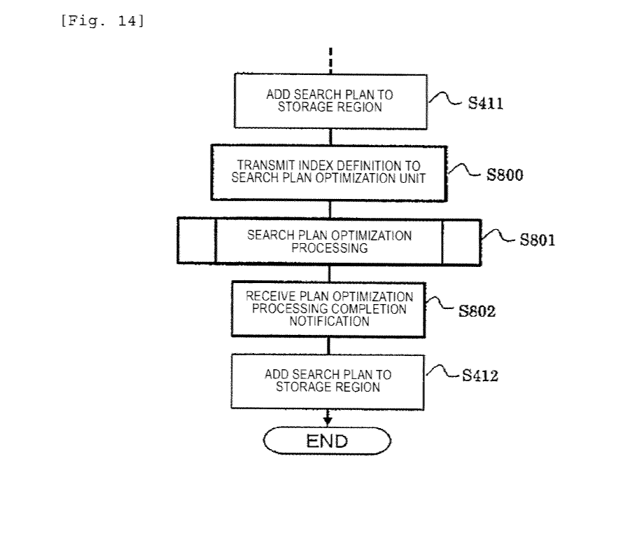

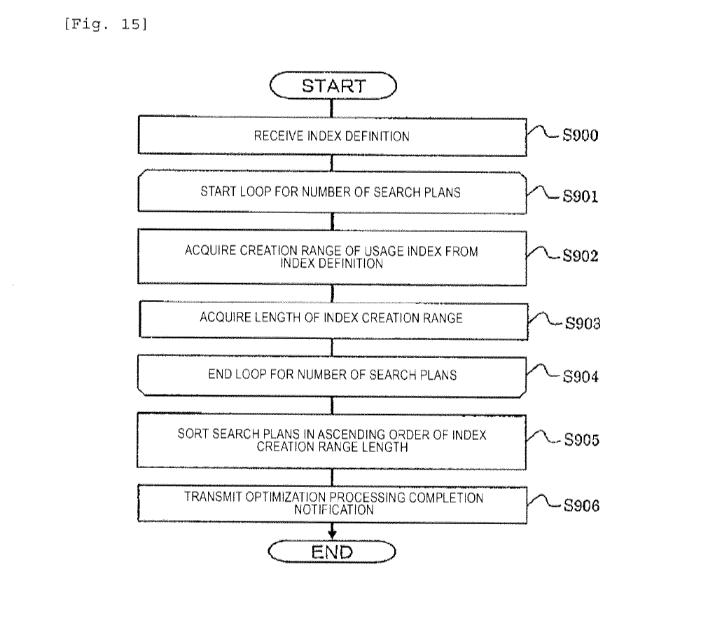

FIG. 14 shows the flow of processing of the search plan determination unit 22B in the second embodiment. In this processing, a processing step is added between S411 and S412 of the processing (FIG. 8) of the search plan determination unit 22A in the first embodiment, and other processing is the same as in the first embodiment. An additional portion will be described (for convenience, the processing of S411 and S412 of FIG. 8 is described in FIG. 14).

In S411, the search plan determination unit 228 adds the created search plan to the storage region of the data search plan 44.

Next, in S800, the search plan determination unit 22B transmits the definition information of the index definition file 43 to the search plan optimization unit 201, and instructs the search plan optimization unit 201 to optimize the search plan.

In S801, optimization processing by the search plan optimization unit 201 is executed, and after the processing is completed, in S802, the search plan determination unit 22B receives a processing completion notification.

Thereafter, in S912, the search plan determination unit 22B transmits the processing completion notification to the data search unit 20, and ends the processing.

FIG. 15 shows the flow of processing of the search plan optimization unit 201.

The search plan optimization unit 201 starts processing in response to the instruction to optimize the search plan from the search plan determination unit 22B. At this time, multiple search plans are stored in the storage region of the data search plan 44.

In S900, the search plan optimization unit 201 receives the index definition file 63 from the search plan determination unit 22B. The search plan optimization unit 201 repeats a series of processing of S901 to S904 for the number of search plans stored in the storage region of the data search plan 44.

In S902, the search plan optimization unit 201 acquires the creation range (for example, the creation rage 67 of FIG. 3) of the usage index stored in the search plan from the definition information of the index definition file.

In S903, the search plan optimization unit 201 acquires the length of the index creation range. Here, the term “length of index creation range” refers to the text length of a portion designated as a range where an index is created on document data. In order to compare the sizes of multiple index creation ranges, a value, such as a byte length or the number of characters, is acquired from document data. A length acquired from sample data randomly selected from document data may be used, or an average value in all pieces of document data may be used.

If the processing is completed for the number of search plans, the processing progresses to S905.

In S905, the search plan optimization unit 201 sorts the search plans stored in the storage region of the data search plan 44 in an ascending order of the length of the index creation range.

Finally, in S906, the search plan optimization unit 201 transmits a completion notification to the search plan determination unit 22B, and the processing ends.

After the processing of the search plan determination unit 22B ends, the data search unit 20 calls the search execution unit 21, and processes the search plan in the sorted order by the search plan optimization unit 201. The search execution unit 21 does not execute processing for a document determined to be a correct document by a search plan previously executed in subsequent search plans.

As described above, when the search target range can be divided into multiple index creation ranges, search processing is performed from an index created in a narrower range, and a search with a subsequent index is performed using the result. Since there is an increasing possibility that an index created in a narrower range requires a short time for a search, there is an increasing possibility that a search ends fast by confirmation from the index.

### Third Embodiment

Next, a computing system 300 of a third embodiment to which the invention is applied will be described. This embodiment has a feature that, when multiple indexes having different characteristics are created in the same range, a usage index or an order of indexes is determined according to the requirements of the search request or the characteristics of the indexes.

The characteristics of the indexes are as follows: “character string search index” using an n-gram described above, a suffix array, or the like, “key search index”, such as a B-tree, in which a specific key character string (a character string having continuous numerical values, a character string matching a regular expression, a chemical formula or English word, or the like) is extracted and registered, “filtering index” which expresses the presence/absence of a character string with “1” and “0” of a bitmap like an n-gram-based signature file, and the like (for example, PTL 3).

The “filtering index” can perform a fast search despite search noise. Accordingly, noise in the result searched with the filtering index is removed with a character string search index or actual data. With this, it is possible to concentrate detailed search processing only on a document narrowed down with the filtering index and to realize a fast search.

Since the “key search index” can search a registered key with high accuracy, when a character string of the same type as a registered key character string is included in the search request, the portion of the character string is searched with a key search index, and other character strings are searched with a character string search index or actual data. Specifically, in the computing system 300, an n-gram index and a B-tree in which a character string having continuous numerical values is registered are created. When “10 cm” is designated as a search request, the portion of “10” in the search request is searched with the B-tree, the portion of “cm” is searched with the n-gram index, and a document in which these partial character strings are continuous is found. If “10 cm” is searched only with the n-gram index, “110cm”, “10010 cm”, or the like becomes a correct document. Meanwhile, with the use of this embodiment, it is possible to exclude a document including these keys and to obtain a search result with high accuracy. Furthermore, it is possible to perform a range search of a key character string portion by utilizing the characteristics of the B-tree.

The configuration of the computing system 300 basically has the same configuration as those in the first and second embodiments, and a major difference is a search plan determination unit 22C.

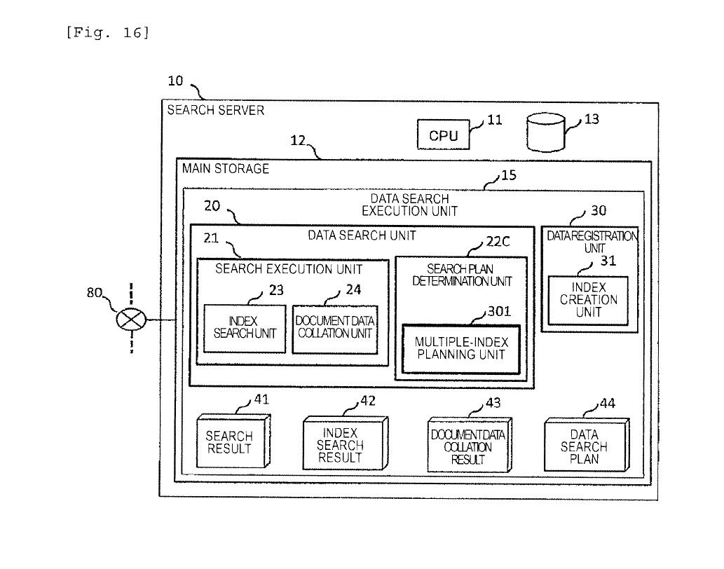

FIG. 16 schematically shows the configuration of the data search server 10. The search plan determination unit 22C has a multiple-index planning unit 301.

In the multiple-index planning unit 301, a “search plan” is rearranged such that a search using an index for more efficient processing is preferentially executed from the relationship between characteristics of indexes and a search character string included in a search request.

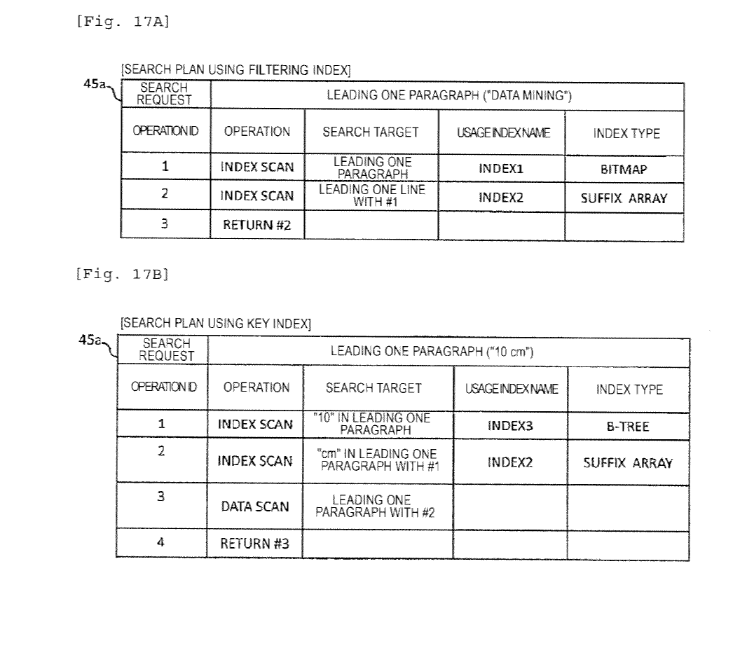

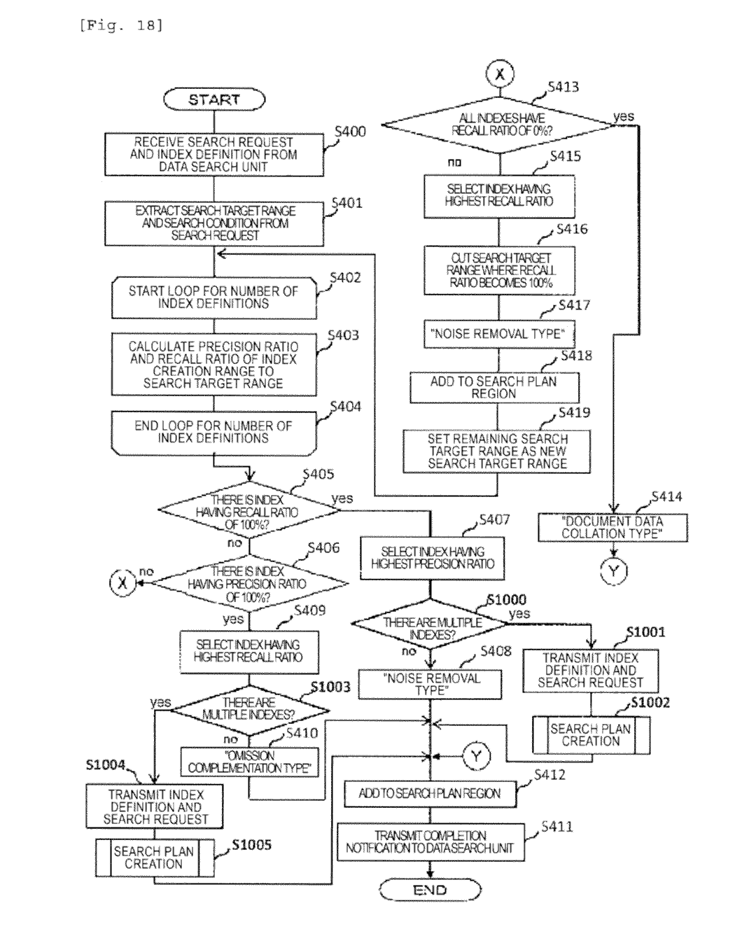

In the third embodiment, an example of a data search plan created by the search plan determination unit 22C is shown in FIG. 17. A search plan stores a search request and a processing procedure. The processing procedure is constituted by multiple operations, and one operation includes an operation ID, an operation, a search target, a usage index name (blank when no index is used), and an index type.

FIG. 17A shows an example of a search plan using a “filtering index”. A search is performed using INDEX1 of a bitmap as a filtering index through an operation 1, a search is performed using INDEX2 of a suffix array as a character string search index for a matching document in the operation 1 through an operation 2, and the result is returned.

FIG. 17B shows an example of a search plan using a “key index”. “10” is searched using INDEX3 of a B-tree as a key search index through an operation 1, and “cm” is searched using INDEX2 of a suffix array as a character string search index for a matching document in the operation 1 through an operation 2, and a result that the appearance positions of “10” and “cm” are adjacent to each other is returned.

The configuration of the computing system 300 is described above.

Hereinafter, the flow of processing of the search plan determination unit 22C is shown.

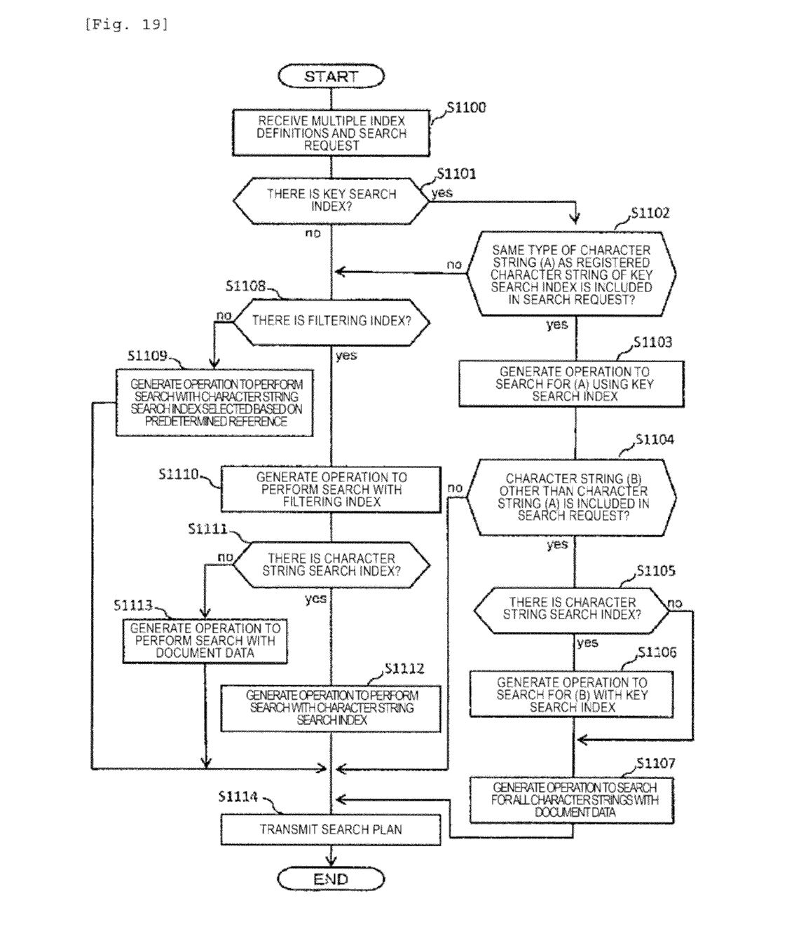

FIG. 18 shows the flow of processing of the search plan determination unit 22C. The processing of the search plan determination unit 23 is based on the processing (FIG. 8) of the search plan determination unit 22A of the first embodiment, and a difference is that Steps S1000 to S1002 and S1003 to S1005 are added. In the additional steps, when there are multiple selected indexes, a usage index or an order of indexes is determined according to the requirements of the search request or the characteristics of the indexes. In particular, additional portions will be described, and detailed description of overlapping portions will not be repeated.

In S405, the search plan determination unit 22C checks whether or not there is an index having a recall ratio of 100% from the precision ratio and the recall ratio of the index creation range to the search target range calculated in the processing of S400 to S404. When there is an index having a recall ratio of 100% (S405: Yes), the processing progresses to S407, and when there is no index having a recall ratio of 100% (S405: No), the processing progresses to S406.

In S407, the search plan determination unit 22C selects an index having the highest precision ratio among indexes having a recall ratio of 100%.

In S1000, the search plan determination unit 22C checks whether or not there are multiple indexes having the highest precision ratio, when there are multiple indexes having the highest precision ratio (S1000: Yes), the processing progresses to S1001, and when there is one index having the highest precision ratio (S1000: No), the processing progresses to S408 and a “noise removal type” search plan is created.

In S1001, the search plan determination unit 22C transmits the selected index definition and the search request to the multiple-index planning unit 301, and then, in S1002, causes the multiple-index planning unit 301 to execute search plan creation processing. Detailed processing of the multiple-index planning unit 301 will be described below.

Next, the flow of processing of S1003 to S1005 will be described.

In S405, when there is no index having a recall ratio of 100% (S405: No), in S406, the search plan determination unit 22C checks whether or not there is an index having a precision ratio of 100%. When there is no index having a precision ratio of 100% (S406: No), the processing progresses to S413, and when there is an index having a precision ratio of 100% (S406: Yes), the processing progresses to S1003.

In S1003, the search plan determination unit 22C checks whether or not there are multiple indexes having the highest precision ratio, when there are multiple indexes having the highest precision ratio (S1003: Yes), the processing progresses to S1004, and when there is one index having the highest precision ratio (S1003: No), the processing progresses to S410 and an “omission complementation type” search plan is created.

In S1004, the search plan determination unit 22C transmits the selected index definition and the search request to the multiple-index planning unit 301, and then, in S1005, causes the multiple-index planning unit 301 to execute search plan creation processing. Detailed processing of the multiple-index planning unit 301 will be described below.

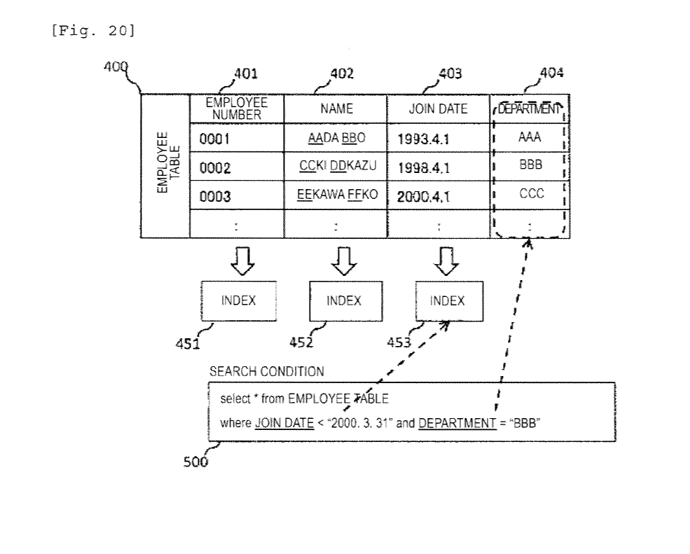

FIG. 19 shows the flow of processing of the multiple-index planning unit 301.

In S1100, the multiple-index planning unit 301 receives the index definition of multiple indexes and the search request from the search plan determination unit 22C.

In S1101, the multiple-index planning unit 301 checks whether or not there is a key search index in the received index definition. When it is determined that there is a key search index (S1101: Yes), the processing progresses to S1102, and when it is determined that there is no key search index (S1101: No), the processing progresses to S1108.

In S1102, the multiple-index planning unit 301 checks whether or not a character string (A) of the same type as a key character string registered in the “key search index” is included in the search request. When it is determined that the character string (A) is not included in the search request (S1102: No), the processing progresses to S1108, and when it is determined that the character string (A) is included in the search request (S1102: Yes), the processing progresses to S1103.

In S1103, the multiple-index planning unit 301 generates an operation to search for the character string (A) using the “key search index”.

In S1104, the multiple-index planning unit 301 checks whether or not a character string (B) other than the character string (A) is included in the search request. When it is determined that the character string (B) is not included in the search request (S1104: No), the processing progresses to S1114, and when it is determined that the character string (B) is included in the search request (S1104: Yes), the processing progresses to S1105.

In S1105, the multiple-index planning unit 301 checks whether or not there is a “character string search index”. When it is determined that there is a “character string search index” (S1105: Yes), the processing progresses to S1106, and when it is determined that there is no “character string search index” (S1105: No), the processing progresses to S1107.

In S1106, the multiple-index planning unit 301 generates an operation to search for the character string (B) using the “character string search index”.

In S1107, the multiple-index planning unit 301 generates an operation to search for all character strings using document data, and progresses to S1114. This operation becomes an operation to extract a position where the character string (A) and the character string (B) are adjacent to each other.

In the meantime, in S1108, the multiple-index planning unit 301 checks whether or not there is a “filtering index”. When it is determined that there is no “filtering index” (S1108: No), the processing progresses to S1109, and when it is determined that there is a “filtering index” (S1108: Yes), the processing progresses to S1110.

In S1109, the multiple-index planning unit 301 generates an operation to perform a search using a “character string search index” selected on a predetermined reference. As the predetermined reference, an index with low processing cost may be selected, or any index may be selected randomly. Thereafter, the processing progresses to S1114.

In S1110, the multiple-index planning unit 301 generates an operation to perform a search using the “filtering index”.

In S1111, the multiple-index planning unit 301 checks whether or not there is a “character string search index”. When it is determined that there is a “character string search index” (S1111: Yes), the processing progresses to S1112, and an operation to perform a search using the “character string search index” is generated. In S1111, when it is determined that there is no “character string search index” (S1111: No), the processing progresses to S1113, an operation to perform a search using document data is generated, and then, the processing progresses to S1114.

Finally, in S1114, the multiple-index planning unit 301 transmits a search plan to the search plan determination unit 22C, and ends this flow.

In this way, according to the computing system 300, when multiple indexes having different characteristics are created in the same range, a usage index or an order of indexes is determined according to the requirements of the search request or the characteristics of the indexes, and a search is performed. As shown in this embodiment, optimization is made so as to preferentially use a “key search index” conforming to a specific key character string or a fast “filtering index”, whereby it is possible to realize fast search processing with high accuracy.

The computing system 300 of the third embodiment is described above.

The invention is not limited to the above-described embodiments, and includes various modification examples. For example, the invention is not necessarily limited to embodiments including all components described. A part of components of a certain embodiment can be added to or can be replaced with components of another embodiment without departing from the spirit and scope of the invention.

The above-described components, functional units, processing units, processing, and the like may be implemented by hardware by designing a part or all of the above-described components, functional units, processing units, processing, and the like using, for example, an integrated circuit, or functions may be implemented by cooperation between software and a CPU. Information, such as a program, a table, and file, which implements these functions may be placed in a recording device, such as a memory, a hard disk, an SSD (Solid State Drive), or a recording medium, such as an IC card, and SD card, or a DVD.

Control lines and information lines which are considered to be necessary for the description are shown, and all control lines and information lines of a product are not necessarily shown. It may be assumed that almost all components are connected together in practice.

### REFERENCE SIGNS LIST

10: search server, 15: data search execution unit, 22A, 22B, 22C: search plan determination unit, 23: index search unit, 24: document data collation unit, 30: data registration unit, 41: search result, 42: index search result, 43: document data collation result, 44: data search plan, 61: index data, 62: document data, 63: index definition file, 201: search plan optimization unit, 301: multiple-index planning unit

1. A computing machine comprising:
a storage unit which stores an index definition including information representing an index creation range of a search index created for a data group; and
a control unit which detects, from a search target range included in a search request for the data group and the index definition, an inclusion relationship of at least a part of one of the search target range and the index creation range, executes an index search using the search index in response to the search request by the detection of the inclusion relationship, then executes an actual data search in the search target range for document data excluding data, for which success or failure of a search request has been finalized by the index search, in response to the search request, and outputs a search result for the search request.

2. The computing machine according to claim 1,
wherein the control unit executes an index search using the search index by the detection of an inclusion relationship in which the search target range is greater than the index creation range, and then executes an actual data search in the search target range excluding the index creation range for document data excluding data, for which establishment of a search request has been finalized by the index search, in response to the search request.

3. The computing machine according to claim 1,
wherein the control unit executes an index search using the search index by the detection of an inclusion relationship in which the search target range is smaller than the index creation range, and then executes an actual data search in the search target range for document data excluding data, for which non-establishment of a search request has been finalized by the index search, in response to the search request.

4. The computing machine according to claim 1,
wherein the control unit detects the inclusion relationship by calculating the ratio of the search target range included in the index creation range and the ratio of the index creation range included in the search target range.

5. The computing machine according to claim 4,
wherein the control unit executes the index search using a search index having the highest ratio of the index creation range included in the search target range among search indexes for which the ratio of the search target range included in the index creation range is 100%.

6. The computing machine according to claim 4,
wherein the control unit executes the index search using a search index having the highest ratio of the search target range included in the index creation range among search indexes for which the ratio of the index creation range included in the search target range is 100%.

7. The computing machine according to claim 4,
wherein, when both of the ratio of the index creation range included in the search target range and the ratio of the search target range included in the index creation range are not 100% and the ratio of the search target range included in the index creation range is not 0%, with respect to a search index having the highest ratio of the search target range included in the index creation range, the control unit generates a search index in an index creation range not included in the search target range such that the ratio becomes 100%, and executes the index search.

8. The computing machine according to claim 1,
wherein, when the inclusion relationship is not detected, the control unit executes an actual data search in the search target range in response to the search request.

9. The computing machine according to claim 1,
wherein, before executing the index search, the control unit acquires, from an index definition corresponding to a search index for use in the index search, the length of an index creation range of the search index, and executes an index search using a search index in an ascending order of the length of the index creation range.

10. The computing machine according to claim 1,
wherein the index definition further includes information representing the format of the search index,
before executing the index search, the control unit acquires, from an index definition corresponding to a search index for use in the index search, the index format of the search index,
when a search character string included in the search request is included in a registered character string of a key search index, the control unit preferentially executes the index search using a search index having the key search index format,
when there is no search index of the key search index format or a search character string included in the search request is not included in a registered character string of a key search index, the control unit preferentially executes the index search using a search index of a filtering index format,
the control unit executes the index search using a search index having the key search index format or the index search using a search index of a filtering index format, and
the control unit then preferentially executes the index search using a search index of a character string index format.

11. A non transitory computer-readable recording medium storing a program which causes a computer to execute:
a procedure for reading an index definition including information representing an index creation range of a search index created for a data group from a storage device and detecting, from a search target range included in a search request for the data group and the index definition, an inclusion relationship of at least a part of one of the search target range and the index creation range;
a procedure for executing an index search using the search index in response to the search request by the detection of the inclusion relationship;
a procedure for then executing an actual data search in the search target range for document data excluding data, for which success or failure of a search request has been finalized by the index search, in response to the search request; and
a procedure for outputting a search result for the search request.

12. The recording medium according to claim 11,
wherein the program causes the computer to further execute:
a procedure for executing an index search using the search index by detecting an inclusion relationship in which the search target range is greater than the index creation range; and
a procedure for then executing an actual data search in the search target range excluding the index creation range for document data excluding data, for which establishment of a search request has been finalized by the index search, in response to the search request.

13. The recording medium according to claim 11,
wherein the program causes the computer to further execute:
a procedure for executing an index search using the search index by detecting an inclusion relationship in which the search target range is smaller than the index creation range; and
a procedure for then executing an actual data search in the search target range for document data excluding data, for which non-establishment of a search request has been finalized by the index search, in response to the search request.

14. A data search method which causes a computing machine to execute:
reading an index definition including information representing an index creation range of a search index created for a data group from a storage device;
detecting, from a search target range included in a search request for the data group and the index definition, an inclusion relationship of at least a part of one of the search target range and the index creation range;
executing an index search using the search index in response to the search request by the detection of the inclusion relationship;
then executing an actual data search in the search target range for document data excluding data, for which success or failure of a search request has been finalized by the index search, in response to the search request; and
outputting a search result for the search request.
